(19) United States
(12) Patent Application Publication
(10) Pub. No.: US 2014/0365200 A1
(43) Pub. Date: Dec. 11, 2014

(54) SYSTEM AND METHOD FOR AUTOMATIC SPEECH TRANSLATION

(71) Applicant: LEXIFONE COMMUNICATION SYSTEMS (2010) LTD., Haifa (IL)

(72) Inventor: Isaac SAGIE, Haifa (IL)

(21) Appl. No.: 13/910,163

(22) Filed: Jun. 5, 2013

(51) Int. Cl. G06F 17/28

(52) U.S. Cl. CPC G06F 17/289
USPC 704/2

(57) ABSTRACT

A method for automatic translation of spoken speech in a first language to a second language includes applying a plurality of different speech recognition engines to the spoken speech. Each speech recognition engine produces a candidate transcript of the speech. At least one translation engine is applied to at least one of the candidate transcripts to produce at least one candidate translation of a candidate transcript into the second language. If a candidate translation is determined to be valid, selecting, in accordance with a criterion, a candidate translation for output.

### FIELD OF THE INVENTION

The present invention relates to automatic speech translation.

### BACKGROUND OF THE INVENTION

Automated voice translation may be designed to translate words that are spoken in one language by a speaker to another language. For example, the speaker may be speaking into a transmitter or microphone of a telephone, or into a microphone or sound sensor of another device (e.g., a computer or recording device). The speech is then translated into another language. The translated speech may be heard by a listener via a receiver or speaker of the listener's telephone, or via another speaker (e.g., of a computer).

Automated voice translation is often performed in three steps. In the first step, speech recognition (speech to text) is applied to convert each spoken sentence to text. In the second step, machine translation is applied to the text to translate a sentence of the text from the speaker's language to a text sentence in the listener's language. Finally, speech synthesis (text to speech) is applied to the translated text to vocalize each translated sentence. Software applications (often referred to as “engines”) are commercially available to perform the three steps.

### SUMMARY OF THE INVENTION

There is thus provided, in accordance with some embodiments of the present invention, a method for automatic translation of spoken speech in a first language to a second language, the method including: applying a plurality of different speech recognition engines to the spoken speech, each speech recognition engine producing a candidate transcript of the speech; applying at least one translation engine to at least one of the candidate transcripts to produce at least one candidate translation of the candidate transcript into the second language; and if the candidate translation is determined to be valid, selecting, in accordance with a criterion, a candidate translation for output.

Furthermore, in accordance with some embodiments of the present invention, applying the translation engine includes applying a plurality of different translation engines to said at least one of the candidate transcripts to produce the candidate translation.

Furthermore, in accordance with some embodiments of the present invention, applying the translation engine includes applying a plurality of different translation engines to a plurality of the candidate transcripts.

Furthermore, in accordance with some embodiments of the present invention, the method includes identifying a voice sentence in the spoken speech, wherein applying the plurality of speech recognition engines includes applying the speech recognition engines to the voice sentence.

Furthermore, in accordance with some embodiments of the present invention, each candidate transcript is characterized by a recognition confidence level, and the candidate translation is determined to be valid only when that candidate translation is a translation of a candidate transcript whose characterizing recognition confidence level is greater than a threshold recognition confidence level.

Furthermore, in accordance with some embodiments of the present invention, the method includes selecting one of the candidate transcripts in accordance with the speech recognition engine that was applied to the spoken speech to produce that one of the candidate transcripts.

Furthermore, in accordance with some embodiments of the present invention, the plurality of speech recognition engines includes a grammatical recognition engine, a statistical recognition engine, or a dictation recognition engine.

Furthermore, in accordance with some embodiments of the present invention, applying the plurality of speech recognition engines includes utilization of a language model or a modifier that is selected in accordance with a translation profile, the translation profile being specific to at least one of a speaker of the spoken speech, a population of speakers, or a context of the spoken speech.

Furthermore, in accordance with some embodiments of the present invention, each of the candidate translations is characterized by a translation confidence level, and the candidate translation is determined to be valid only when the translation confidence level that characterizes that candidate translation is greater than a threshold translation confidence level.

Furthermore, in accordance with some embodiments of the present invention, selecting in accordance with the criterion includes comparing the translation confidence levels that characterize each of the candidate translations.

Furthermore, in accordance with some embodiments of the present invention, the criterion includes a translation engine that was applied to the candidate transcript to produce that candidate translation.

Furthermore, in accordance with some embodiments of the present invention, the translation engines comprise a grammatical translation engine, a semantic translation engine, or a free language translation engine.

Furthermore, in accordance with some embodiments of the present invention, the method includes applying speech synthesis to the selected candidate translation.

Furthermore, in accordance with some embodiments of the present invention, the method includes soliciting an action from a user if the candidate translation is determined to be invalid.

Furthermore, in accordance with some embodiments of the present invention, the action includes repeating the spoken speech.

Furthermore, in accordance with some embodiments of the present invention, applying the translation engine includes utilization of a language model or a modifier that is selected in accordance with a translation profile.

There is further provided, in accordance with some embodiments of the present invention, a system for automatic translation of spoken speech in a first language to a second language, the system including a processor configured to: apply a plurality of different speech recognition engines to the spoken speech, each speech recognition engine producing a candidate transcript; characterize each candidate transcript by a recognition confidence level; apply a plurality of translation engines to a candidate transcript of the plurality of candidate transcripts to produce a candidate translation of that candidate transcript into the second language; characterize each candidate translation by a translation confidence level; determine if a candidate translation is valid; select, in accordance with a criterion, a candidate translation for output by the output device.

Furthermore, in accordance with some embodiments of the present invention, the system includes an input channel to receive the spoken speech.

Furthermore, in accordance with some embodiments of the present invention, the system includes an output channel for outputting the selected candidate translation.

There is further provided, in accordance with some embodiments of the present invention, a non-transitory computer readable storage medium having stored thereon instructions that, when executed by a processor, will cause the processor to perform the method of; applying a plurality of different speech recognition engines to spoken speech in a first language, each of the recognition engines producing a candidate transcript of the speech; applying at least one translation engine to at least one of the candidate transcripts to produce at least one candidate translation of the candidate transcripts into a second language; and if the candidate translation is determined to be valid, selecting, in accordance with a criterion, a candidate translation for output.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1A schematically illustrates a system for automatic speech translation, in accordance with an embodiment of the present invention.

FIG. 1B schematically illustrates a device for automatic speech translation, in accordance with an embodiment of the present invention.

FIG. 2 is a block diagram of processes related to automatic speech translation, in accordance with an embodiment of the present invention.

FIG. 3 is a block diagram of speech processing related to automatic speech translation, in accordance with an embodiment of the present invention.

FIG. 4 is a block diagram of speech transcription for automatic speech translation, in accordance with an embodiment of the present invention.

FIG. 5 is a block diagram of transcript translation and validation for automatic speech translation, in accordance with an embodiment of the present invention.

FIG. 6A schematically illustrates a learning process for automatic speech translation, in accordance with an embodiment of the present invention.

FIG. 6B schematically illustrates details of the learning process illustrated in FIG. 6A.

FIG. 7 is a flowchart depicting a method for automatic speech translation, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

In accordance with embodiments of the present invention, a segment (e.g., a sentence, phrase, or clause) of speech that is spoken by a user or speaker in a first language (hereinafter the “user language”) is translated for delivery to a party or listener in a second language (hereinafter the “translated language”).

The translation includes applying a plurality of speech recognition engines to the (or a segment of) spoken speech to produce a corresponding plurality of text transcriptions, or transcripts, of the speech. Each of the transcripts may be characterized by a level of confidence. One of the transcriptions is selected for further processing on the basis of its characterizing level of confidence. For example, the transcript that is characterized by the highest confidence level (indicating that the corresponding transcription, among all of the produced transcripts, has the greatest likelihood of being accurate) may be selected. Selection of a transcript may be based on additional considerations (e.g., preference to one transcription or speech recognition engine, algorithm, or technique over another).

In some cases, when none of the indicated confidence levels meets a criterion for acceptance, none of the produced transcripts may be accepted. The translation process may be interrupted or aborted for that speech. The speaker may be prompted to repeat the speech, to correct or select one of the transcripts, or otherwise act to facilitate automatic speech translation.

A plurality of translation engines is applied to the selected transcription to produce a corresponding plurality of translations of the transcribed speech into text in the translated language. Each of the translated texts is characterized by a level of confidence. One of the translated texts may be selected to be output for delivery to the listener on the basis of its characterizing level of confidence. The output translated text may be present visually to the listener (e.g., displayed or printed), or may be converted by a speech synthesizer to audible speech in the second language.

Application of automatic speech translation, in accordance with embodiments of the present invention, may be advantageous over speech translation techniques that merely cascade the various steps (e.g., transcription followed by translation and speech synthesis). In a cascaded technique, an error that is made in one step (e.g., transcription) may not be detected or corrected. Thus, the likelihood of an inaccurate or unintelligible translation into the party's language could be increased in the absence of automatic speech translation in accordance with an embodiment of the present invention.

One or more translation profiles may be defined and utilized to facilitate automatic speech translation. A translation profile may be appropriate to a specific user or speakers, to a population of users or speakers, or to a particular context or environment. A translation profile may include one or more language models, vocabularies, or grammars.

For example, a public translation profile may be common to all users that speak in a given user language, or whose speech is to be translated to a given translated language. For example, the public translation profile may include a general purpose language model, vocabulary or grammar.

A domain translation profile may be specific to a particular field, context, or environment. The domain translation profile may include a language model, vocabulary, or grammar for a specific domain. For example, a domain may include a field such as health, hospitality, security, or other fields. A domain may include a context or environment such as a type of convention, conversation, or meeting (e.g., business, sales, marketing, field of engineering or science, trial, between professional peers or between professional and a layman, or other contexts or environments), a venue for the conversation (e.g., hospital, laboratory, restaurant, courtroom, or other venues).

An organization translation profile may be specific to all users that are associated with a particular organization. For example, an organization may include a company, a department or unit of a company, a government agency, a professional association, or other groups of users that may share a common terminology or an interest in common subjects. The organization profile may include a language model, vocabulary or grammar for users that are associated with a specific organization.

A personal translation profile may be specific to a particular user or to a user in a particular context (e.g., work or home environment). A personal translation profile may a adapted to a user's personal language model, vocabulary and grammar.

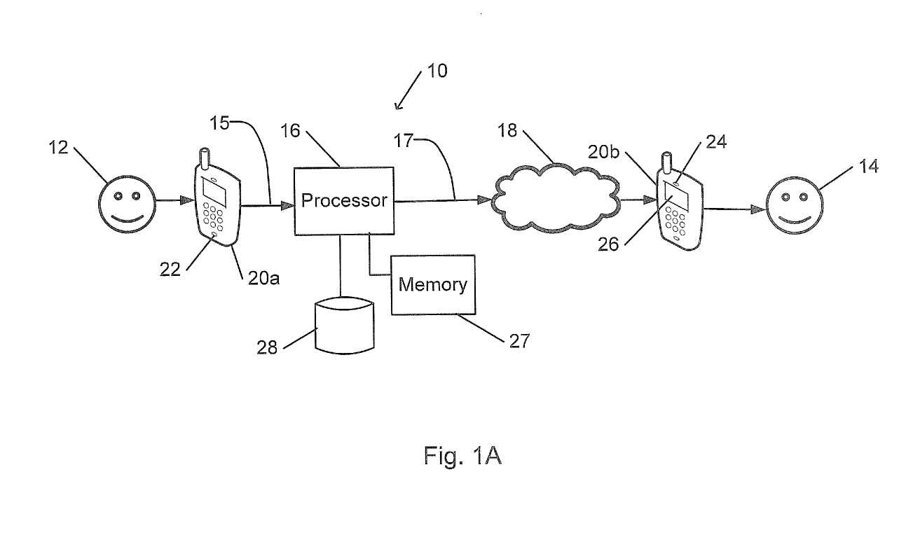

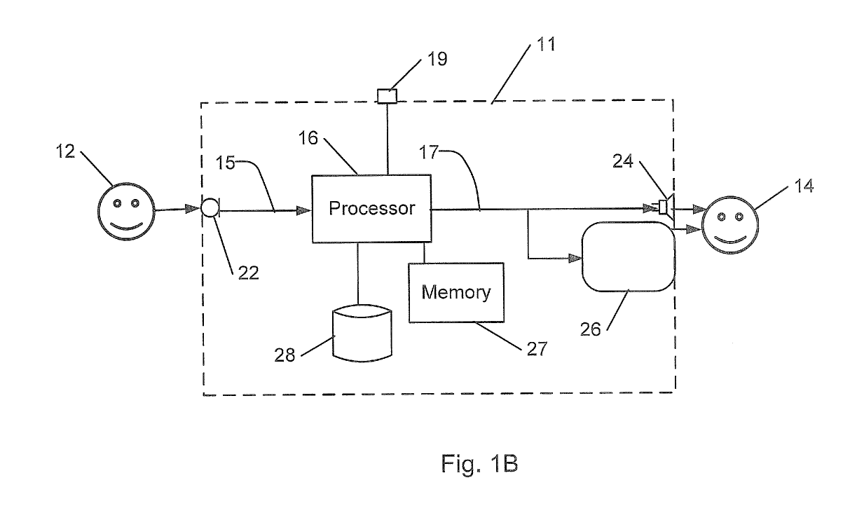

FIG. 1A schematically illustrates a system for automatic speech translation, in accordance with an embodiment of the present invention. Automatic speech translation system 10 enables user 12, speaking in the user language, to be understood by party 14, who understands the translated language.

User 12 and party 14 may be at remote locations from one another. In this case, automatic speech translation system 10 may communicate with different devices. User 12 is associated with user device 20a and party 14 is associated with party device 20b. For example, one or both of user device 20a and party device 20b may include a telephone, a mobile telephone, a smartphone, a mobile or stationary computer, an intercom, a component of a public address system, a radio or other communications transceiver, or other device that may be configured or utilized to detect speech or output a translation of the speech.

Translation processor 16 may be incorporated into user device 20a, party device 20b, another device (e.g., a remote server), or some or all of the above (e.g., with processing capability or functionality divided among the various devices). User device 20a and party device 20b may communicate with one another via network 18. Network 18 may represent a wired or wireless telephone connection, mobile (e.g., cellular) telephone connection, network connection (e.g., Internet or local area network (LAN) connection), an intercom system, public address system, or other connection that enables a person to speak to another at a remote connection.

User 12 speaks into microphone 22 of user device 20a. Microphone 22 is capable of converting a sound to an electronic speech signal. The electronic speech signal may be received by translation processor 16 via input channel 15. The electronic signal may be processed by translation processor 16, and the processed signal may be output to party device 20b via output channel 17. The electronic speech signal, the processed signal, or both, may be transmitted via network 18. Although, for convenience, network 18 is illustrated as connecting output channel 17 with party device 20b, other configurations are possible. For example, alternatively or in addition to connecting output channel 17 with party device 20b, network 18 may connect user device 20a to input channel 15.

User device 20a may represent a telephone, a mobile telephone, a smartphone, a transceiver, an intercom transmitter component, a transmitter component of a public address system, a receiver component of a dedicated automatic translation device, or another device capable of converting a sound to an electronic signal for transmission or processing. Input channel 15 represents a port or communications channel or connection (e.g., electric, electromagnetic, optical, or other) that is appropriate to an electronic speech signal that is produced by automatic speech translation system 10.

Translation processor 16 may represent a processor of user device 20a, of party device 20b, or of another dedicated or multipurpose device (e.g., server or other separate processing device). Translation processor 16 is configured to analyze a signal that represents speech by user 12 in the user language, and to convert the signal to a signal that represents a translation of the contents of the speech into the translated language.

Translation processor 16 may communicate with memory 27. Memory 27 may include one or more volatile or nonvolatile memory devices. Memory 27 may be utilized to store, for example, programmed instructions for operation of translation processor 16, data or parameters for use by translation processor 16 during operation, or results of operation of translation processor 16.

Translation processor 16 may communicate with data storage device 28. Data storage device 28 may include one or more fixed or removable nonvolatile data storage devices. For example, data storage device 28 may include a computer readable medium for storing program instructions for operation of translation processor 16. It is noted that storage device 28 may be remote from translation processor 16. In such cases storage device 28 may include a storage device of a remote server storing instructions for a method for automatic speech translation module in the form of an installation package or packages that can be downloaded and installed for execution by translation processor 16. Data storage device 20 may be utilized to store data or parameters for use by translation processor 16 during operation, or results of operation of translation processor 16.

A signal, either before or after processing by translation processor 16, may be transmitted by network 18 to party device 20b. Party device 20b may represent a telephone, a mobile telephone, a smartphone, a communications transceiver, an intercom receiver (e.g., speaker) component, a receiver (e.g., speaker) component of a public address system, or another device capable of receiving and outputting a processed electronic signal representing translated speech. A processed signal that represents translated speech may be output by one or more output devices. Output channel 17 represents a port or communications channel or connection (e.g., electric, electromagnetic, optical, or other) that is appropriate to an electronic speech signal that is produced by user device 20a. For example, the translated speech may be converted to an audio signal by a speech synthesizer and output as sound by speaker 24. Alternatively or in addition, the signal may be presented visually (e.g., as text) on display screen 26. Output in the form of a video movie or clip may be output concurrently by speaker 24 and display screen 26.

User 12 and party 14 may be near one another, e.g., in a single room or sitting at a single table, together with a device that is configured for automatic speech translation. In this case, a system for automatic speech translation system may be incorporated into a single device.

FIG. 1B schematically illustrates a device for automatic speech translation, in accordance with an embodiment of the present invention.

Automatic speech translation device 11 may include a device that is configurable receive speech that is spoken by user 12 in a first language and output a translation of the speech into a second language for presentation to party 14. For example, automatic speech translation device 11 may represent a desktop, wall mounted, portable, or other device that is configurable to translate speech spoken by a nearby (e.g., in the same room) user 12 for the benefit of a similarly nearby party 14. As another example, automatic speech translation device 11 may be plugged into, or otherwise be connected to, an intercom, telephone, computer, or other connection to intercept and translate speech that is transmitted via the connection.

Automatic speech translation device 11 may include, or be connectable to or communicate with, a microphone 22 for converting speech to an speech signal for input to translation processor 16 via input channel 15. For example, microphone 22 may be incorporated into automatic speech translation device 11, or may otherwise (e.g., remotely) communicate with input channel 15.

Automatic speech translation device 11 may include, or be connectable to or communicate with, a speaker 24 or display screen 26 for outputting translated speech. For example, speaker 24 or display screen 26 may be incorporated into automatic speech translation device 11, or may otherwise (e.g., remotely) communicate with output channel 17.

Automatic speech translation device 11 may include, or be connectable to or communicate with (e.g., remotely), a control 19. For example, control 19 may be operated by user 12, party 14, or by another operator of automatic speech translation device 11. Operation of control 19 may control operation of automatic speech translation device 11. For example, operation of control 19 may cause automatic speech translation device 11 to begin translation, to stop translation, or select or change a language (e.g., reverse a direction of the translation such that speech in what was previously the second language is now translated to what was previously the first language).

User device 20a, party device 20b, and translation processor 16 may be incorporated into a single device (e.g., a computer or a dedicated translation device), as separate components or as separate functionality of a single component or set of components. In this case, network 18 may represent internal connections between components or functionality of automatic speech translation system 10.

Translation processor 16 (e.g., of either automatic speech translation system 10 or of automatic speech translation device 11) may operate in accordance with programmed instructions for operation of a method for automatic speech translation. The programmed instructions may be organized, or for convenience may be described as being organized, into various components, processes, routines, functions, or modules.

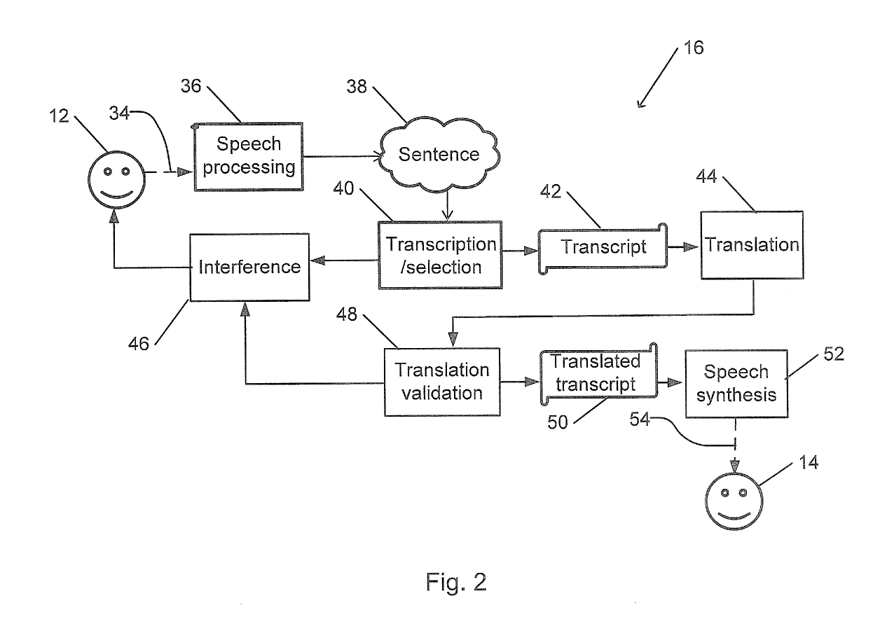

FIG. 2 is a block diagram of processes related to automatic speech translation, in accordance with an embodiment of the present invention.

User speech 34 of user 12 and in the user language may be processed by speech processing 36. User speech 34 is converted to an electronic signal (e.g., as a Waveform Audio File Format, or *.wav, file). An amount of user speech 34 that is converted to a signal and further processed may be limited to a predetermined length. For example, user speech 34 may be limited by a predetermined time limit (e.g., 15 seconds or another time limit). User speech 34 may be limited by a predetermined number of phonemes, or by another limit. For example, a limit of user speech 34 may be selected such that user speech 34 includes a single sentence, or a small number of short related sentences.

Speech processing 36 analyzes the signal representing user speech 34 and outputs voice sentence 38. Speech processing 36 for construction of voice sentence 38 may include, for example, detecting an end of the speech or a sentence or filtering out unrelated sounds. Speech processing 36 may distinguish between speech that is to be translated and other sounds or noises that originate from user 12 or elsewhere and that need not be translated.

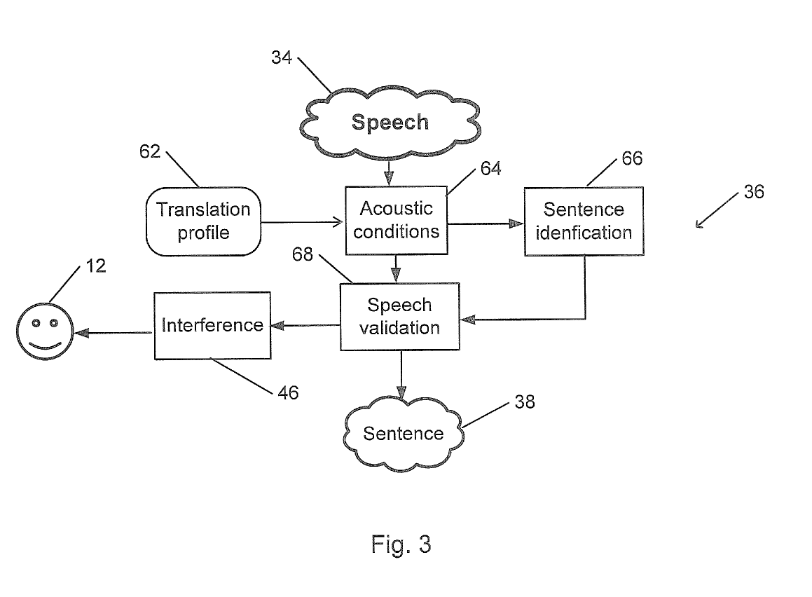

FIG. 3 is a block diagram of speech processing related to automatic speech translation, in accordance with an embodiment of the present invention.

Speech processing 36 may refer to translation profile 62. For example, user 12 may be identified as associated with a device that is implementing speech processing 36, or during a login, initialization, or startup process. One or more profiles or states may have been previously associated with user 12 or with a population of users. The profile or state may be associated with a particular user 12, with a population of users, or with a context of a conversation. The profile or state may be created or defined during a previously implemented learning process. Translation profile 62 may be utilized to identify a profile or state that may affect speech processing 36. Translation profile 62 may identify the user language or may characterize a speech pattern that is associated with user 12. For example, a translation profile 62 may be utilized to characterize pause patterns associated with user 12 (e.g., personal, regional, dialectical, or cultural), typical background noise patterns, intonation patterns (e.g., personal, regional, dialectical, or cultural), or other relevant information.

Acoustic conditions 64 may be assessed. For example, acoustic conditions 64 may be determined by spectral analysis of user speech 34, or by other techniques known in the art, such as signal-to-noise ratio (SIR) analysis, reverberation analysis, or other techniques. Acoustic conditions 64 may identify background noise, interference, or echoes. Validation 68 may determine whether the determined acoustic conditions 64 are suitable for further processing related to automatic speech translation. If acoustic conditions 64 are unsuitable, system interference 46 may be activated. System interference 46 may interrupt user speech 34 by user 12. For example, user 12 may be prompted or requested to repeat user speech 34 under more favorable conditions. For example, user 12 may be requested to move to a suitably quiet area, to modify conditions to eliminate background noise, or to speak more loudly or more clearly.

In accordance with some embodiments of the present invention, a suitable filter may be applied to eliminate background noise or other undesirable conditions.

If acoustic conditions 64 are suitable, sentence identification 66 may be applied to identify voice sentence 38. Sentence identification 66 may utilize one or more techniques known in the art, such as end-of-speech determination or other techniques.

Speech validation 68 may be applied to determine the validity of voice sentence 38. For example, sentence identification 66 may provide an indication of a level of confidence of sentence identification 66. If speech validation 68 determines that speech identification 66 has failed to provide a valid sentence, system interference 46 may be applied. System interference 46 may prompt user 12 to repeat user speech 34 in a more favorable manner. For example, user 12 may be requested to move to a suitably quiet area, to modify conditions to eliminate background noise, to speak more loudly or more clearly, to pause at the end of a sentence or to otherwise indicate termination of user speech 34, or to otherwise improve the quality of user speech 34.

If speech validation 68 determines that voice sentence 38 is valid, transcription and selection process 40 (FIG. 2) is applied to voice sentence 38 to produce sentence transcript 42.

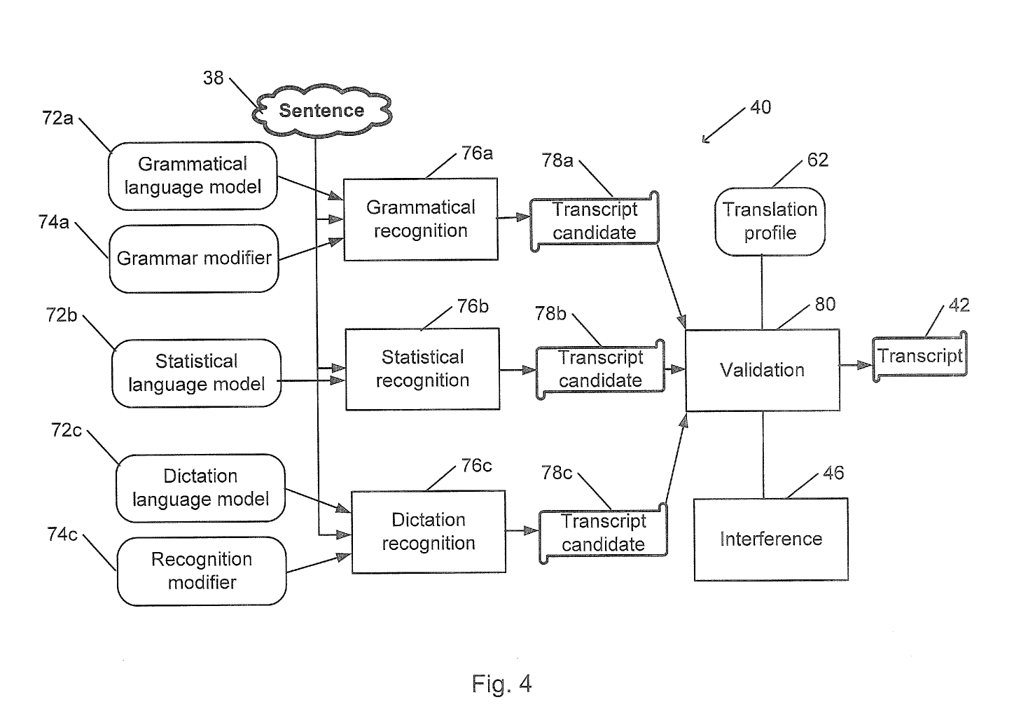

FIG. 4 is a block diagram of speech transcription and transcript selection for automatic speech translation, in accordance with an embodiment of the present invention.

Transcription and selection process 40 includes a plurality of speech recognition engines 76a-76c. For example, voice sentence 38 may be processed (e.g., concurrently or sequentially) by grammatical recognition engine 76a, by statistical recognition engine 76b, and by dictation recognition engine 76c. Other combinations of two or more speech recognition engines may be used.

Application of a speech recognition engine 76a-76c to voice sentence 38 may be constrained in accordance with translation profile 62. For example, a language model or modifier appropriate to translation profile 62 may be absent (e.g., not constructed or insufficient as determined by statistical considerations).

Each speech recognition engine 76a-76c processes a signal that represents voice sentence 38, and outputs a signal (e.g., a text in the user language) that represents a transcript candidate 78a-78c. Transcript candidates 78a-78c are examined by transcript validation process 80. One of transcript candidates 78a-78c is selected by transcript validation process 80 and output as sentence transcript 42.

Each speech recognition engine 76a-76c utilizes an appropriate language model 72a-72c. For example, grammatical recognition engine 76a utilizes grammatical language model 72a, statistical recognition engine 76b utilizes statistical language model 72b, and dictation recognition engine 76c utilizes dictation language model 72c. In addition, a speech recognition engine 76a-76c may utilize one or more language modifiers 74a-74c. For example, grammatical recognition engine 76a utilizes grammar modifiers 74a, and dictation recognition engine 76c utilizes recognition modifiers 74c. Language models 72a-72c and language modifiers 74a-74c may be selected in accordance with translation profile 62.

Operation of grammatical recognition engine 76a is based on matching voice sentence 38 with grammatical patterns. Grammatical recognition matches voice sentence 38 against all sentences that can be created from a given grammar and its modifiers. (The terms “grammar” and “grammatical” as used herein refer to formal rules for combining elements to form a regular expression in a regular language.) Voice sentence 38 may be expected to match a sentence that is selected from a limited set of sentences (and their grammatical modifications or rearrangements).

Grammatical recognition engine 76a may utilize a recognition technique based on grammatical rules such as is known in the art to process formal grammar specifications as specified by grammatical language model 72a. Grammatical language model 72a may be specific to a particular translation profile 62 or to a particular user language. Grammatical language model 72a may be shared among several characterized by different translation profiles 62. However, each translation profile 62 may specify a different grammar modifier 74a. (For example, a grammar modifier 74a may include a list of names of employees or members of different organizations that share a grammatical language model 72a.)

Grammatical recognition engine 76a may match voice sentence 38 against all sentences that can be created in accordance with a given grammatical language model 72a and grammar modifier 74a. The best match is selected to be output as grammatical recognition transcript candidate 78a. Grammatical recognition transcript candidate 78a is associated with (e.g., encoded within grammatical recognition transcript candidate 78a or otherwise output) a confidence level that indicates a degree of match between grammatical recognition transcript candidate 78a and voice sentence 38.

Operation of statistical recognition engine 76b is based on matching voice sentence 38 with statistical patterns. Statistical recognition engine 76b may apply a recognition technique, based on statistical grammar building and as known in the art, to voice sentence 38 in accordance with statistical language model 72b.

Statistical language model 72b may be specific to a particular translation profile 62 or to a particular user language, Statistical language model 72b may be constructed through recording and manual transcription of sample sentences that may be related to one or more translation profiles 62 (e.g., spoken by the user, by a population of speakers to which the user belongs, or by speakers speaking in a particular context or domain) or to a user language.

Statistical recognition engine 76b matches voice sentence 38 against statistical language model 72b. The best match is selected to be output as statistical recognition transcript candidate 78b. Statistical recognition transcript candidate 78b is associated with a confidence level that indicates a degree of match between statistical recognition transcript candidate 78b and voice sentence 38.

Operation of dictation recognition engine 76c is based on matching voice sentence 38 with general statistical patterns (e.g., associated with a public profile or based on large corpora of texts or sentence samples). Dictation recognition engine 76c may apply to voice sentence 38 a recognition technique known in the art that is based on building a statistical grammar from analysis of large corpora. Dictation recognition engine 76c utilizes dictation language model 72c. Dictation language model 72c may be common to all users that are associated with a public profile, or to contexts that share a domain profile.

One or more recognition modifiers 74c may be utilized by dictation recognition engine 76c to adapt dictation language model 72c to a particular translation profile 62.

Dictation recognition engine 76c matches voice sentence 38 against a sentence that is included in dictation language model 72c. The best match is selected to be output as dictation recognition transcript candidate 78c. Dictation recognition transcript candidate 78c is associated with a confidence level that indicates a degree of match between dictation recognition transcript candidate 78c and voice sentence 38.

Additional or alternative recognition engines, e.g., based on emotion or intonation detection, or other techniques, may be utilized.

Validation process 80 selects one of transcript candidates 78a-78c to be output as sentence transcript 42.

Validation process 80 utilizes a computer voting algorithm to select one of transcript candidates 78a-78c as the most accurate representation of voice sentence 38. The algorithm may evaluate factors in addition to the confidence level that is associated with each transcript candidate 78a-78c. Additional factors may be organized in a state table that represents various states that are associated with the current translation profile 62. For example, one of transcript candidates 78a-78c may be associated with a low confidence level by its corresponding speech recognition engine 76a-76c. However, during, or as a result of, application of system interference 46, a user may confirm that candidate transcript as being accurate. In this case, that candidate transcript may be assigned a maximum confidence level.

If the confidence levels that are associated with all three candidates are below a minimum threshold level (e.g., 40% of maximum, or another level), system interference 46 may be applied. For example, as a result of application of system interference 46, the user may be prompted to repeat user speech 34 (FIG. 3), or may be prompted to select one of transcript candidates 78a-78c, to clarify by selecting one option among several in an ambiguous transcription, or to correct one of transcript candidates 78a-78c.

Validation process 80 may rank or give a preference to one of transcript candidates 78a-78c based on the method utilized to produce that transcript candidate. In the following example, a result of application of grammatical recognition engine 76a is preferred over a result of application of statistical recognition engine 76b. Similarly, a result of application of statistical recognition engine 76b is preferred over a result of application of dictation recognition engine 76c:

A translation profile 62 may enable application of grammatical recognition engine 76a. In this case, if the confidence level of grammatical recognition transcript candidate 78a is greater than confidence levels of other transcript candidates, then the computer voting algorithm may select grammatical recognition transcript candidate 78a as sentence transcript 42.

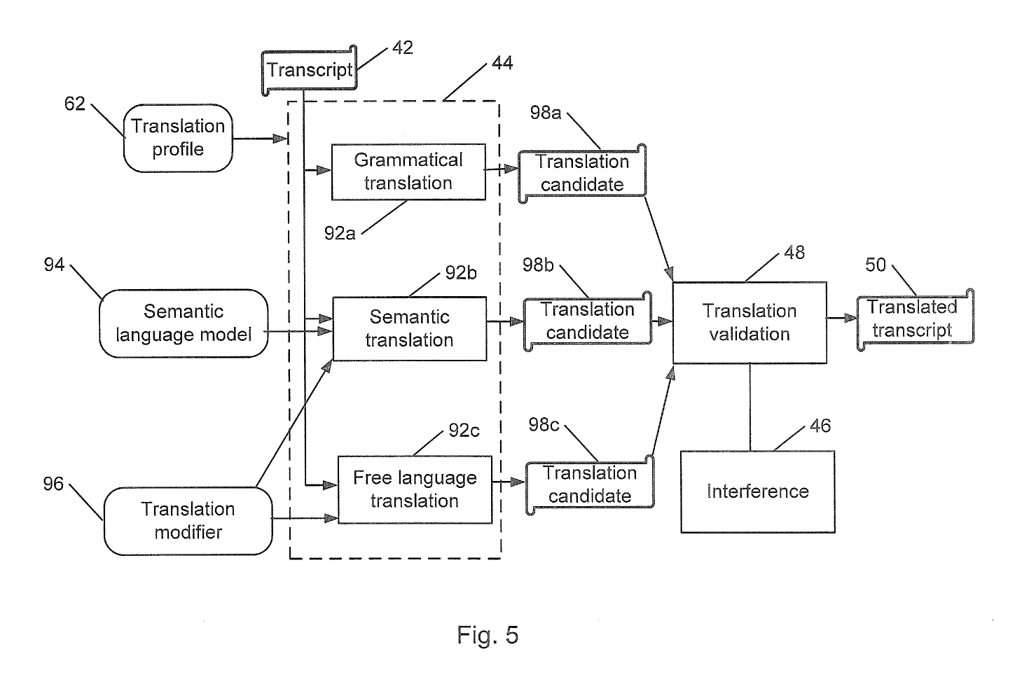

Application of grammatical recognition engine 76a may be enabled. A confidence level of grammatical recognition transcript candidate 78a may be slightly lower (e.g., as determined by a range or threshold level) than confidence levels that are associated with the other transcript candidates. If application of grammatical translation engine 92a (FIG. 5) to grammatical recognition transcript candidate 78a results in a grammatical translation candidate 98a (FIG. 5), then the computer voting algorithm may select grammatical recognition transcript candidate 78a as sentence transcript 42.

Translation profile 62 may not enable application of grammatical recognition engine 76a but may enable application of statistical recognition engine 76b. In this case, if the confidence level of statistical recognition transcript candidate 78b is greater than confidence levels of other transcript candidates, then the computer voting algorithm may select statistical recognition transcript candidate 78b as sentence transcript 42.

A confidence level associated with dictation recognition transcript candidate 78c may be slightly greater (e.g., as determined by a range or threshold level) than a confidence level that is associated with grammatical recognition transcript candidate 78a. In this case, the computer voting algorithm may select grammatical recognition transcript candidate 78a as sentence transcript 42.

In other cases, the transcript candidate associated with the highest level of confidence may be selected as sentence transcript 42.

Other examples of preferences to results of speech recognition engines may be utilized or applied.

Translation process 44 and translation validation 48 may be applied to sentence transcript 42 in the user language to produce translated transcript 50 in the translated language (as shown in FIG. 2).

FIG. 5 is a block diagram of sentence translation and validation for automatic speech translation, in accordance with an embodiment of the present invention.

Translation process 44 includes application of a plurality of translation engines 92a-92c to sentence transcript 42. For example, sentence transcript 42 may be processed (e.g., concurrently or sequentially) by grammatical translation engine 92a, by semantic translation engine 72b, and by free language translation engine 92c. Other combinations of two or more translation engines may be used.

Application of a translation engine 92a-92c to sentence transcript 42 may be constrained in accordance with translation profile 62. For example, a language model, modifier, grammar, or other data appropriate to translation profile 62 may be absent (e.g., not defined or constructed, or insufficient as determined by statistical considerations).

Each translation engine 92a-92c processes a signal that represents sentence transcript 42 and outputs a signal (e.g., a text in the translated language) that represents a translation candidate 98a-98c. Translation candidate 98a-98c are examined by translation validation process 48. One of translation candidates 98a-98c is selected by translation validation process 48 and output as translated transcript 50.

Operation of grammatical translation engine 92a is based on matching sentence transcript 42 with prepared grammatical translation scripts (e.g., including recognized sentences). When a match is found, a corresponding translated sentence is output as grammatical translation candidate 98a in the translated language. Grammatical translation candidate 98a is associated with (e.g., encoded within grammatical translation candidate 78a or otherwise output) a confidence level that indicates a degree of match between grammatical translation candidate 78a and sentence transcript 42.

In accordance with an embodiment of the present invention, if sentence transcript 42 corresponds to grammatical recognition transcript candidate 78a (FIG. 4), and application of grammatical translation engine 92a successfully produces a grammatical translation candidate 78a, then grammatical translation engine 92a alone may be applied to sentence transcript 42 (e.g., if translation engines 92a-92c are applied sequentially).

Semantic translation engine 92b utilizes a process of matching sentence transcript 42 with a semantic pattern. (A semantic pattern is similar to grammatical pattern as discussed above in connection with grammatical translation engine 92a. However, the term “semantic” is used when applied to a text sentence instead of to a voice sentence.)

Semantic translation engine 92b may utilize a statistical semantic model matching technique known in the art to process formal semantic specifications as specified by semantic language model 94. Semantic language model 94 may be specific to a particular translation profile 62. Semantic translation engine 92b may be adapted to a particular translation profile 62 by utilizing an appropriate translation modifier 96. For example, translation modifier 96 may enable semantic translation engine 92b to handle special cases, apply custom dictionaries, correct common errors, or otherwise adapt to a translation profile 62.

Application of semantic translation engine 92b to transcript 42 may produce semantic translation candidate 98b in the translated language. Semantic translation candidate 98b is associated with a confidence level that indicates a degree of match between semantic translation candidate 78a and sentence transcript 42.

In accordance with an embodiment of the present invention, semantic translation engine 92b may be applied to sentence transcript 42 (e.g., in parallel with free language translation engine 92c) only if sentence transcript 42 corresponds to statistical recognition transcript candidate 78b or to dictation recognition transcript candidate 78c (FIG. 4).

Free language translation engine 92c applies a text translator known in the art (e.g., a commercially available text translator) to sentence transcript 42 to produce free language translation candidate 98c in the translated language. Free language candidate 98c may be associated with a confidence level that indicates a degree of match between free language translation candidate 78a and sentence transcript 42. Free language translation engine 92c may be adapted to a particular translation profile 62 by utilizing an appropriate translation modifier 96. For example, translation modifier 96 may enable free language translation engine 92c to handle special cases, apply custom dictionaries, correct common errors or otherwise adapt to a translation profile 62.

In accordance with an embodiment of the present invention, free language translation engine 92c may be applied to sentence transcript 42 (e.g., in parallel with semantic translation engine 92b) only if sentence transcript 42 corresponds to statistical recognition transcript candidate 78b or to dictation recognition transcript candidate 78c.

Translation process 44 may utilize other translation engines.

Translation validation process 48 utilizes a computer voting algorithm to select one of translation candidates 98a-98c as translated transcript 50, representing the best translation of sentence transcript 42 or of voice sentence 38.

Translation validation process 48 may be driven by factors in addition to a confidence level associated with each encoded in each translation candidate 98a-98c. Additional factors may be organized in a state table that represents various states that are associated with the current translation profile 62.

There may, at times, be no clear selection of a translation candidate 98a-98c. For example, the confidence levels that are associated with all translation candidates may be below a minimum threshold level (e.g., 40% of maximum, or another level). In this case, system interference 46 may be applied. For example, as a result of application of system interference 46, the user may be prompted to repeat user speech 34 (FIG. 3), or may be prompted to select one of translation candidates 98a-98c, to clarify by selecting one option among several in an ambiguous transcription, or to correct one of transcript candidates 98a-98c.

Translation validation process 48 may rank or give a preference to one of translation candidates 98a-98c based on the method utilized to achieve that translation candidate. In the following example, a result of application of grammatical translation engine 92a is preferred over a result of application of semantic translation engine 92b. Similarly, a result of application of semantic translation engine 92b is preferred over a result of application of free language translation engine 92c:

If sentence transcript 42 corresponds to grammatical recognition transcript candidate 78a, and application of grammatical translation engine 92a to sentence transcript 42 successfully produces a grammatical translation candidate 98a, then grammatical translation candidate 98a is selected as translated transcript 50.

If sentence transcript 42 corresponds to grammatical recognition transcript candidate 78a, but no grammatical translation candidate 98a was produced, then free language translation candidate 98c is selected as translated transcript 50.

If sentence transcript 42 corresponds to statistical recognition transcript candidate 78b or to dictation recognition transcript candidate 78c, and semantic translation candidate 98b was produced and is associated with a higher confidence level than free language translation candidate 98c, then semantic translation candidate 98b is selected as translated transcript 50.

If sentence transcript 42 corresponds to statistical recognition transcript candidate 78b or to dictation recognition transcript candidate 78c, and no semantic translation candidate 98b was produced, then free language translation candidate 98c is selected as translated transcript 50.

In other cases, the translation candidate associated with the highest level of confidence may be selected as translated transcript 50.

Other examples of preferences to results of speech recognition engines may be utilized or applied.

Translated transcript 50 may be presented to party 14. For example, translated transcript 50 may be displayed as text on display screen 26 (FIG. 1A or FIG. 1B).

In accordance with some embodiments of the present invention, and as illustrated in FIG. 2, speech synthesis process 52 may be applied to translated transcript 50. Application of speech synthesis process 52 to translated transcript 50 creates audible translated speech 54 in the translated language which may be heard and understood by party 14. Application of speech synthesis process 52 may include application of a speech synthesis technique known in the art. Audible translated speech 54 may be generated using, for example, speaker 24 (FIG. 1A or FIG. 1B).

Concurrent with operation of translation processor 16 (FIG. 1A or FIG. 1B), a learning process may operate. The learning process enables continuous (or period) updating of data that is utilized in operation of translation processor 16. The learning process includes offline review of results of operation of translation processor 16.

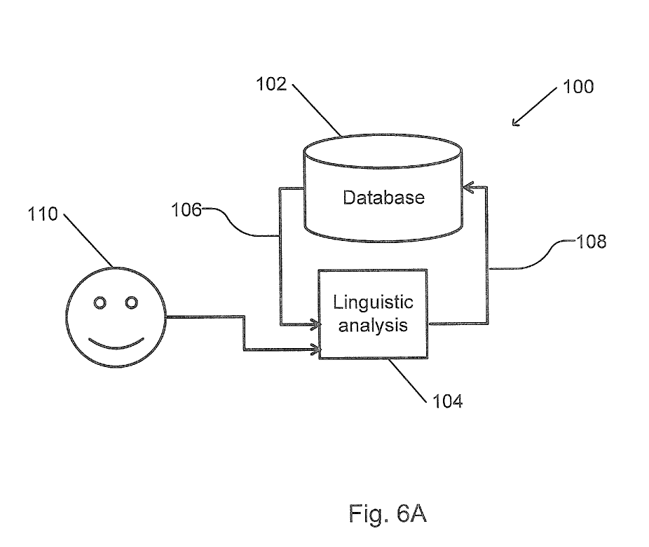

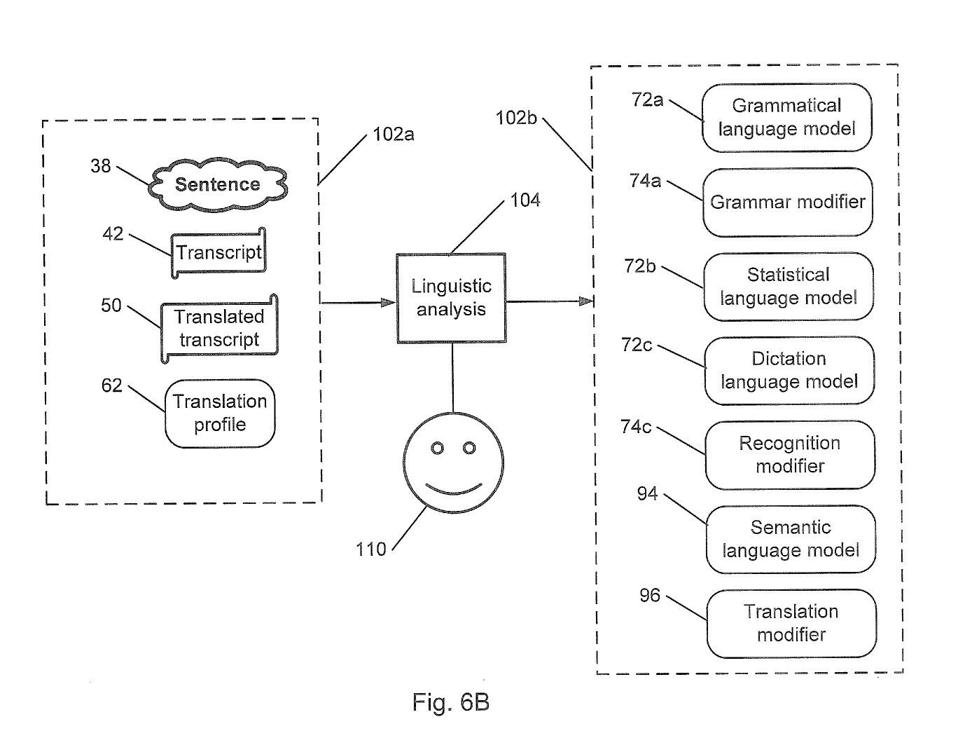

FIG. 6A schematically illustrates a learning process for automatic speech translation, in accordance with an embodiment of the present invention. FIG. 6B schematically illustrates details of the learning process illustrated in FIG. 6A.

Learning process 100 includes maintaining database 102. Database 102 includes voice database 102a and language model database 102b. Database 102 may be stored on data storage device 28 of automatic speech translation system 10 (FIG. 1A) or of automatic speech translation device 11 (FIG. 1). For example, database 102 may be stored on a memory device associated with a server (e.g., accessible via network 18), with user device 20a, or with party device 20b.

As translation process 16 operates, a voice sentence 38, its associated translation profile 62, and its corresponding sentence transcript 42, its translated transcript 50, or both, may be stored in voice database 102a. For example, every voice sentence 38 that is detected together with its associated profile and transcripts may be stored, or selected voice sentences 38 and their associated profiles and transcripts may be stored. Voice sentences 38 may be selected for storing in a random manner (e.g., in accordance with a statistical distribution function), periodically (e.g., according to period of time or number of detected voice sentences 38), or in response to a predetermined condition (e.g., difficulty in performing a process by translation processor 16). Stored data may include a timestamp, levels of confidence, information regarding which transcription or translation was applied, or other data (e.g., related to a context).

Linguistic analysis 104 includes extracting data from voice database 102a that relates to a voice sentence 38. Operations related to linguistic analysis 104 may be executed by translation processor 16, or by another processor with access to database 102. For example, linguistic analysis 104 may be executed on a server, or on another device that is in communication with user device 20a or with party device 20b.

The extracted data may be reviewed by reviewer 110. Reviewer 110 represents a person (e.g., a person familiar with the user language, and possibly the translated language) who may listen to voice sentence 38 or view sentence transcript 42. Reviewer 110 is trained or other capable of confirming the correctness of sentence transcript 42, translated transcript 50, or both, or of correcting a mistake in sentence transcript 42, translated transcript 50, or both. For example, reviewer 110 may manually transcribe or translate voice sentence 38 and compare with sentence transcript 42 and translated transcript 50. Reviewer 110 may also confirm or correct information in translation profile 62. For example, reviewer 110 may determine that a context, or an association of a user with a population, as reflected by translation profile 62 is correct or incorrect (e.g., the user speaks with an accent or in a dialect, the user's speech relates to a subject other than the subject that is suggested by the context, or other details).

As a result of review by reviewer 110, corrections may be made to information that is stored in language model database 102b of database 102. For example, a correction may be made to one or more of grammatical language model 72a, statistical language model 72b, dictation language model 72c, semantic language model 94, grammatical modifier 74a, recognition modifier 74c, or translation modifier 96. One or more associations of a user with a translation profile 62 may be modified.

Learning process 100 may enable continuous improvement of accuracy of operation of translation processor 16.

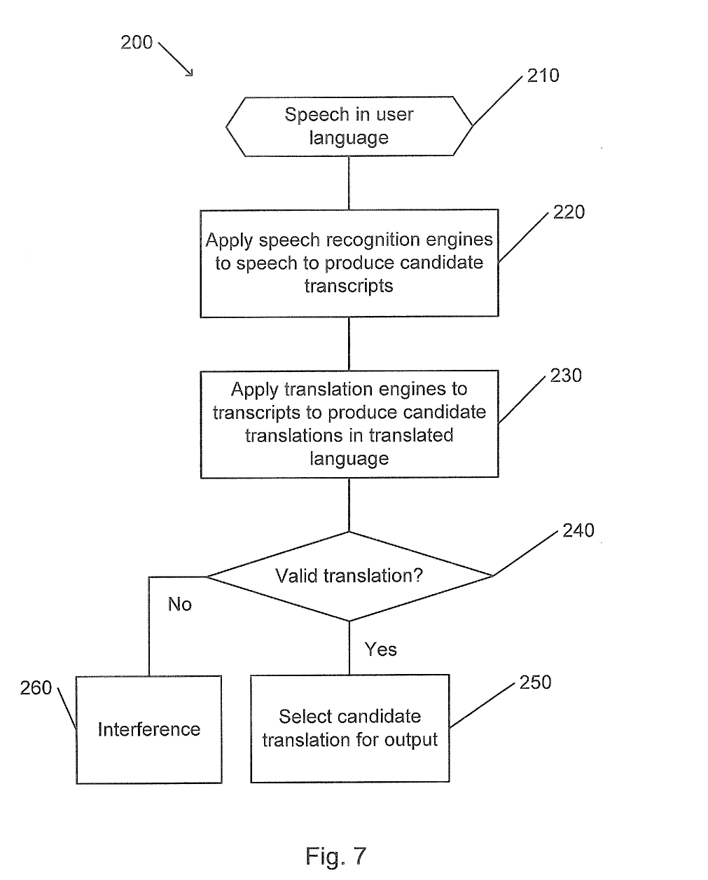

FIG. 7 is a flowchart depicting a method for automatic speech translation, in accordance with an embodiment of the present invention.

Automatic speech translation method 200 may be executed by a translation processor. The translation processor may be incorporated into a device that is associated with (e.g., being operated or held by) a user speaking the user language, a party to whom the content of the user's speech is to be conveyed in a translated language, to a local device (e.g., a machine that is dedicated to automatic speech translation or a computer configured for automatic speech translation), or to a remote device that is in communication with a user's device, the party's device, a local device, or a voice detection device.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Prior to execution of automatic speech translation method 200, a processor, application or device that executes automatic speech translation method 200 may be initialized. For example, initializing may include defining an identity of the user, of the party, or both, defining a venue or context, defining the user language, defining one or more translated languages, measuring a voice level or background noise, speaking a sample sentence, or other activities related to setup, initialization or calibration. Initialization may include manual operation of controls, spoken commands, or other operations.

An initialization operation may indicate a translation profile for the user or the context.

Automatic speech translation method 200 may be executed on speech in a first language, the user language (block 210). For example, the user may indicate (e.g., by pressing a button or otherwise) that the user is about to speak. The speech may be detected and converted to an electrical signal by a microphone, transducer, or similar device.

A plurality of speech recognition engines, applications, methods, or techniques may be applied to the speech (block 220). Application of each speech recognition engine produces a candidate transcript of the speech. Each candidate transcript is characterized by a transcription or recognition confidence level that indicates a degree of match between the candidate transcript and the speech. Speech recognition engines may include, for example, engines for grammatical speech recognition, statistical speech recognition, dictation recognition, or other speech recognition engines. Some or all of the speech recognition engines may utilize an appropriate language model (e.g., including a set of sentences or a template of sentences), or an appropriate modifier (e.g., for adapting or customizing the language model). Language models and modifiers may be determined by a translation profile.

Prior to application of the speech recognition engine, other speech processing may be applied to the speech. For example, the speech processing may distinguish between speech and other sounds or background noise, and may detect within the speech a beginning and end of a voice sentence. A speech recognition engine may then be applied to the voice sentence to produce a candidate transcript.

One or more translation engines may be applied to one or more of the candidate transcripts to produce candidate translations in the translated language (block 230). For example, one of the candidate transcripts may have been selected by a validation process (e.g., on the basis of its associated recognition confidence level, on the basis of the speech recognition engine used to produce the candidate transcript, or on the basis of another consideration). In this case, translation engines may be applied only to the selected candidate transcript. In other cases, translation engines may be applied to two or more of the candidate transcripts. Each candidate translation may be characterized by a translation confidence level.

For example, translation engines may include a grammatical translation engine, a semantic translation engine, a free language translation engine, or other translation engines. Application of a translation engine may include utilization of an appropriate language model or modifier. Selection of a language model or modifier may be determined by an applicable translation profile.

The candidate translations may be evaluated to determine if at least one of the candidate translations is valid (block 240). For example, levels of confidence associated with the candidate transcripts, the candidate translations, or both, may be evaluated. If all of the levels of confidence are low (as compared with predetermined criteria), the candidate translations may be determined to be invalid.

If there is no valid translation candidate, system interference may be applied (block 260). System interference may include soliciting an action by the user. For example, the user may be prompted to repeat the speech, to repeat the speech under better conditions (e.g., more loudly, slowly, clearly or with less background noise). The user may be prompted to indicate (e.g., by operating a control) which of several candidate transcripts or translations is preferred, or to correct a candidate transcript or translation.

If one or more of the candidate translations are valid, one of the candidate translations may be selected, on the basis of predetermined criteria, for output (block 250). For example, criteria may be based on a recognition confidence level, a translation confidence level, a preference for a speech recognition engine or for a translation engine, or on a combination of these and/or other factors.

The translation may be output as text to be displayed on a display screen or printed. Speech synthesis may be applied to convert the translation to an audible sound signal which may be converted to sound by a speaker, earphone, headphone, or similar device. The synthesized sound may accompany a video or still image (e.g., of the user who is speaking). The synthesized sound may be produced in a voice that emulates the user's voice, another's voice (e.g., of a celebrity or other person), or may be in a generic voice.

In accordance with some embodiments of the present invention, transcribed spoken speech may be translated concurrently into several languages (e.g., by a single processor, or by multiple processors that are operating concurrently).

1. A method for automatic translation of spoken speech in a first language to a second language, the method comprising:
applying a plurality of different speech recognition engines to the spoken speech, each speech recognition engine producing a candidate transcript of the speech;
applying at least one translation engine to at least one of the candidate transcripts to produce at least one candidate translation of said at least one of the candidate transcripts into the second language; and
if said at least one candidate translation is determined to be valid, selecting, in accordance with a criterion, a candidate translation of said at least one candidate translation for output.

2. The method of claim 1, wherein applying at least one translation engine comprises applying a plurality of different translation engines to said at least one of the candidate transcripts to produce said at least one candidate translation.

3. The method of claim 1, wherein applying at least one translation engine comprises applying a plurality of different translation engines to a plurality of the candidate transcripts.

4. The method of claim 1, further comprising identifying a voice sentence in the spoken speech, wherein applying the plurality of speech recognition engines comprises applying said plurality of speech recognition engines to the voice sentence.

5. The method of claim 1, wherein each candidate transcript is characterized by a recognition confidence level, and wherein said at least one candidate translation is determined to be valid only when that candidate translation is a translation of a candidate transcript whose characterizing recognition confidence level is greater than a threshold recognition confidence level.

6. The method of claim 1, comprising selecting said at least one of the candidate transcripts in accordance with the speech recognition engine that was applied to the spoken speech to produce said at least one of the candidate transcripts.

7. The method of claim 1, wherein said plurality of speech recognition engines comprises a grammatical recognition engine, a statistical recognition engine, or a dictation recognition engine.

8. The method of claim 1, wherein applying the plurality of speech recognition engines comprises utilization of a language model or a modifier that is selected in accordance with a translation profile, and wherein the translation profile is specific to at least one of a speaker of the spoken speech, a population of speakers, or a context of the spoken speech.

9. The method of claim 1, wherein each of said at least one candidate translation is characterized by a translation confidence level, and wherein said at least one candidate translation is determined to be valid only when the translation confidence level that characterizes that candidate translation is greater than a threshold translation confidence level.

10. The method of claim 9, wherein selecting in accordance with the criterion comprises comparing the translation confidence levels that characterize each of said at least one candidate translation.

11. The method of claim 1, wherein the criterion comprises a translation engine of said at least one translation engine that was applied to said at least one of the candidate transcripts to produce said at least one candidate translation.

12. The method of claim 1, wherein said at least one translation engine comprises a grammatical translation engine, a semantic translation engine, or a free language translation engine.

13. The method of claim 1, further comprising applying speech synthesis to the selected candidate translation.

14. The method of claim 1, comprising soliciting an action from a user if said at least one candidate translation is determined to be invalid.

15. The method of claim 14, wherein the action comprises repeating the spoken speech.

16. The method of claim 1, wherein said applying at least one translation engine comprises utilization of a language model or a modifier that is selected in accordance with a translation profile.

17. A system for automatic translation of spoken speech in a first language to a second language, the system comprising a processor configured to:
apply a plurality of different speech recognition engines to the spoken speech, each speech recognition engine producing a candidate transcript;
characterize each candidate transcript by a recognition confidence level;
apply a plurality of translation engines to a candidate transcript of said plurality of candidate transcripts to produce a candidate translation of said at least one candidate transcript into the second language;
characterize each candidate translation by a translation confidence level;
determine if a candidate translation of said at least one candidate translation is valid;
select, in accordance with a criterion, a candidate translation of said at least one candidate translation for output by the output device.

18. The system of claim 17, comprising an input channel to receive the spoken speech.

19. The system of claim 17, comprising an output channel for outputting the selected candidate translation.

20. A non-transitory computer readable storage medium having stored thereon instructions that when executed by a processor will cause the processor to perform the method of:
applying a plurality of different speech recognition engines to spoken speech in a first language, each of the recognition engines producing a candidate transcript of the speech;
applying at least one translation engine to at least one of the candidate transcripts to produce at least one candidate translation of said at least one of the candidate transcripts into a second language; and
if said at least one candidate translation is determined to be valid, selecting, in accordance with a criterion, a candidate translation of said at least one candidate translation for output.
